(19) United States
(12) Patent Application Publication
(10) Pub. No.: US 2019/0184313 A1
(43) Pub. Date: Jun. 20, 2019

(54) METHOD AND APPARATUS FOR SEPARATING INSOLUBLE LIQUIDS OF DIFFERENT DENSITIES

(71) Applicant: MINEXTECH LLC, Oro Valley, AZ (US)

(72) Inventor: William D. Ernt, Mesa, AZ (US)

(21) Appl. No.: 15/844,317

(22) Filed: Dec. 15, 2017

(51) Int. Cl. B01D 17/02; B04B 5/04; B04B 11/06; B04B 11/02

(52) U.S. Cl. CPC B01D 17/0217; B04B 11/02; B04B 11/06; B04B 5/04

(57) ABSTRACT

An apparatus for separating a mixture of insoluble liquids of different densities includes a stationary housing, and a rotatably mounted separator tank within the housing. The tank has an inlet adjacent the lower end of the tank, and an outlet adjacent the upper end of the tank. An outlet port plate located in an upper end of the rotatably mounted separator tank has a plurality of outlets spaced at different distances from the tank axis of rotation. One or more removable access plates are provided in a top wall of the stationary housing for providing access to removable plugs in the plurality of outlets in the outlet port plate.

### FIELD OF THE INVENTION

The invention relates to method and apparatus for separating two liquids which are different densities and are substantially mutually insoluble or immiscible.

### BACKGROUND OF THE INVENTION

Liquid-liquid separation systems have been used for many years in various industries. In liquid-liquid separation, two liquids of different densities and chemistries and substantially mutually insoluble in one another are separated by gravity or centrifugal action.

A challenge with liquid-liquid separation is to achieve rapid and efficient separation of the two liquids. Conventional settlers rely on gravity to complete the separation. In a conventional “1 g” separation system, the tanks or settlers must be large enough to allow adequate residence time to achieve desired separation, and thus require a lot of space, and expensive construction. In addition the large settler size requires a large volume of each liquid phase. These large volumes increase the cost of operation especially involving a high cost organic solvent. Accordingly, centrifugal separators often are used to reduce the time required for the separation of two immiscible liquids of different densities and reduce the volume of the process liquids. However, the high unit cost of existing liquid-liquid centrifuges restrict the use of these highly efficient liquid-liquid separation devices to relatively low flow volume applications or very specialized applications.

Additionally, both conventional “1 g” gravity settlers and existing centrifugal separators are not closed systems (occupied entirely by the liquids). Thus these operations entrain air in the liquids. Entrained air causes two major problems: a) the air makes the separation of the two liquids more difficult, and b) air may degrade the organic solvent.

Although continuous throughput centrifugal separators have been available for more than 60 years (for example, see U.S. Pat. No. 2,044,996 issued in 1936 to Podbiclniak), the industry still needs a cost-effective continuous centrifuge, which rapidly and efficiently separate two immiscible liquids of different densities with minimum entrainment of one liquid phase in the other.

See also U.S. Pat. No. 4,657,401 which is designed to maximize the liquid-liquid interface for maximum mass transfer without creating droplet sizes that are difficult to separate. As the densities of the two liquids come closer together, the separation becomes more difficult. On the other hand, if the densities of the two liquids differ by a wide margin, the separation becomes faster. Using centrifugal separation, very low entrainment of one liquid in the other liquid is achieved without increasing equipment size. Reducing the entrainment and loss of expensive chemistries become a major operating cost savings. Additionally, environmental costs, permitting procedures and insurance premiums are reduced. It is obvious that all previous designs in the market place are a compromise and designed for specific chemistries and specific processes.

The foregoing discussed in the prior art derives in part from U.S. Pat. No. 6,440,054 in which there is described a mixer-separator apparatus which includes a mixer section with a mixing blade that provides intimate mixing contact between two immiscible liquids of different densities, integrated with a centrifugal separator apparatus for separating the mixture of two immiscible liquids of different densities, the apparatus comprising: a stationary mixer tank having an inlet for the two liquids, and an outlet for the two mixed liquids, emptying into an inlet of a superior mounted separator tank rotatable about an axis extending through the rotatable tank. The rotatable separator tank includes a tank outlet substantially on the axis for light liquids, and a plurality of tank outlets for heavy liquid. The plurality of outlets for the heavy liquid are spaced at different distances from the axis. The centrifuged separator apparatus also includes a deflection baffle between the light liquid outlet and the outlets for the heavy liquid, the deflection baffle substantially lying in a plane transverse to the axis so the baffle has an outer edge spaced from the tank and located a greater distance from the axis than the outlets for the heavy liquid.

While the combination mixer-separator described in the aforesaid U.S. Pat. No. 6,440,054 provides functional mixing and separating of immiscible liquids of densities or specific gravities that are not too close in magnitude to one another, as densities or specific gravities of the two liquids come close together, and droplet size becomes smaller, separation becomes more difficult. U.S. Pat. No. 6,440,054 is designed to both mix the two liquids as well as separate the two liquids of different densities. The mixing speed and the separation speed is always the same since the drive shaft is the same for both unit operations. As the rotational speed in U.S. Pat. No. 6,440,054 increases, the mixing efficiency and mass transfer increases since smaller droplet sizes are created. But as droplet size decreases, separation becomes more difficult. So the operational characteristics of U.S. Pat. No. 6,440,054 is counterproductive. In other words, increasing the rotational speed improves one objective (mass transfer, since droplet size decreases) but reduces separation efficiency since droplet sizes are smaller.

### SUMMARY OF THE INVENTION

The present invention provides a new and unique centrifugal separator system that is capable of separating immiscible liquids with a broader range of different densities or specific gravities with very high efficiencies, resulting in lower operating costs, lower chemical losses, lower maintenance costs and environmental impact.

More particularly, the present invention in one aspect provides a method and apparatus for separating a mixture of two liquids of different densities or specific gravities and which are substantially insoluble in each other, the apparatus comprising:
a stationary housing;
a separator tank within the housing, rotatably mounted about an axis of a center rotating shaft extending through the tank;
the tank having an inlet adjacent the lower end of the tank, for the mixed liquids;
a riser tube and outlet adjacent the upper end of the tank substantially on the axis of rotation;
an outlet port plate in an upper end of the tank below the top of the tank;
a plurality of outlet ports located in the center rotating shaft in the upper part of the tank for collection and discharge of the light phase liquid;
a plurality of outlets for the heavy phase liquid, spaced from the tank inlet, formed through the outlet port plate, the plurality of outlets for adjusting the heavy phase liquid interface being spaced at different distances from the axis; and
a deflection baffle between a lower end of the riser and the weir plate, the deflection baffle substantially lying in a plane transverse to the axis and spaced from the stationary housing.

There are several holes in the center rotating shaft adapted to carry the light phase liquid to the exit port at the top of the unit.

In one aspect, the apparatus includes baffles extending radially outwardly from the axis of rotation, and extending longitudinally in the tank, the outer edge of each baffle being spaced from the tank inner wall.

In another aspect, at least some of the plurality of outlets for the heavy liquid lie on substantially concentric circles. In such aspect, the apparatus preferably includes plugs for selectively closing and opening the outlets for the heavy liquid.

In yet another aspect, the apparatus stationary housing has an opening to provide easy access to the plugs for opening and closing the outlets for the heavy liquid. In such aspect, the apparatus preferably includes a removable cover over the opening in the housing.

### BRIEF DESCRIPTION OF THE DRAWINGS

Further features and advantages of the present invention will be seen from the following detailed description, taking in conjunction with the accompanying drawings, wherein:

FIG. 1 is a side elevational view of a centrifuge separator in according to the present invention;

FIG. 2 is a cross-sectional view thereof;

FIG. 3 is a top plan view thereof;

FIG. 4 is a plan elevational drawing showing details of the light phase outlet; and

FIG. 5 is a top plan view of the heavy phase weir plate of the centrifuge.

### DETAILED DESCRIPTION OF THE INVENTION

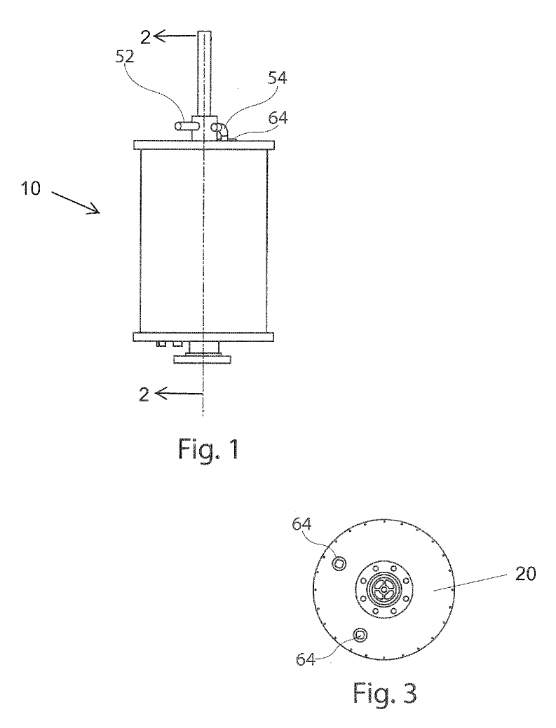

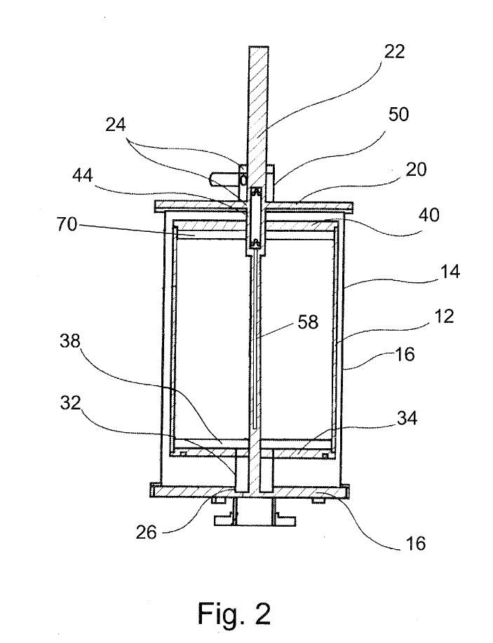

Referring to FIGS. 1-5 of the drawings, a centrifugal separator 10 in according to the present invention comprises a rotatable cylinder 12 in a shape of a vertical right cylinder contained within a cylindrical stationary housing 14 having a vertical side wall 16, a bottom wall 34 and a top wall 20. A vertical drive shaft 22 is supported at the upper end of housing 14 by a pair of thrust bearings and seals 24 and at the lower end of housing 14 by a thrust bearing and seal 26. Centrifugal separator 10 includes a fluid inlet tube 32 extending through the bottom plate 34 of cylinder 12 to the inside of the cylinder 12 for input of, e.g. an organic/aqueous mixed phase liquids of different densities.

A horizontal diverter plate 38 is carried on shaft 22, spaced above bottom plate 34. An upper interface plate 70 is carried on riser tube 44, spaced below horizontal outlet port plate 40 as will be described below. As the organic/aqueous mixed phase is introduced through inlet tube 32, the dispersion travels upwardly through tube 32 and into the bottom of the rotating cylinder 12 where the mixed phase is then deflected towards the outer wall of the rotating cylinder 12.

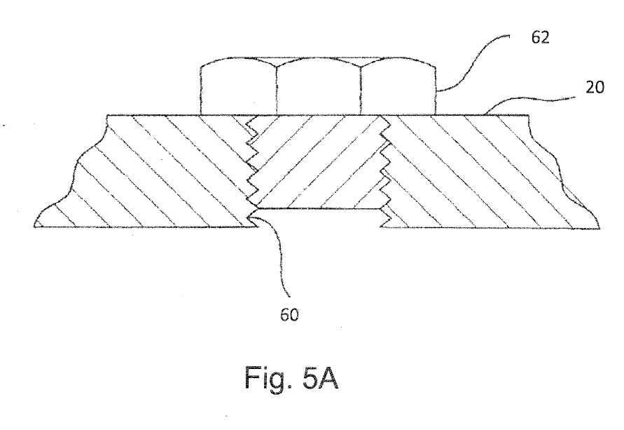

Referring to FIG. 5, at the upper end of rotating cylinder 12 is provided horizontal outlet port plate 40 having a plurality of outlet holes 60 which preferably lie on substantially concentric circles, radially spaced from the center of the plate 40. In order to adjust for different fluid densities, selected outlets 60 may be closed with removable plugs 62. To provide easy access to the outlets, i.e. for adding or subtracting plugs 62, cover 20 includes a removable access plate 64

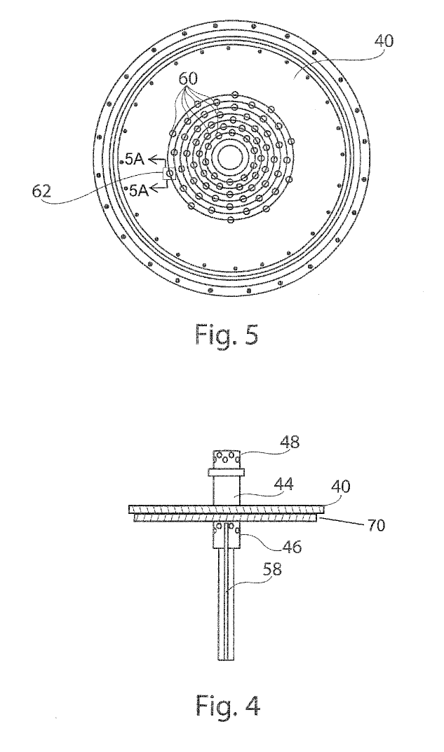

Surrounding shaft 22 and extending through an aperture in plate 40 is a riser tube 44. Riser tube 44 has a plurality of apertures 46 (see FIG. 5) located below plate 40, and a second plurality of apertures 48 located above plate 40. Riser tube 44 extends into a cap 50 which is provided with a light phase outlet 52. A heavy phase outlet 54 is mounted through the top wall of cover 20. Upper interface plate 70 is mounted on riser tube 44, spaced below outlet port plate 40, and a plurality of short vertical plates 58 are mounted on the periphery of shaft 22 (see FIG. 4).

In use, an organic/aqueous mixed phase solution is introduced to the bottom of the rotating cylinder 12 through inlet tube 32. The organic/aqueous mixed phase gets deflected towards the outside wall of the cylinder by diverter plate 38. The rotating cylinder 12, which typically rotates at 100 to 4750 rpm, imparts to the liquid a practically rigid body rotation. The inner surface of the rotating liquid is subjected to high “g's”, and gets separated as it moves upward. The rate of separation depends upon droplet size distribution, densities, viscosities and coalescing behavior of the two liquid phases.

The heavy phase fluid is thrown outward by centrifugal force as it rises in the rotating cylinder 12, while the lighter phase remains closer to the center axis as it rises in the rotating cylinder. The heavy phase fluid passes through holes 60 in top plate 40 where it is then discharged through outlet 54, while the lighter phase enters holes 46 in riser pipe 44 where it is discharged through holes 48 to outlet 52.

The centrifugal separator in the present invention has several advantages over prior art centrifugal separators. For one, the ability to selectively plug outlets in top plate 40 makes the apparatus capable of processing liquids with a large spread between densities. On the other hand, the apparatus also is capable of processing liquids with a narrow spread between densities.

Another important distinction and advantage of the apparatus of the present invention compared to conventional prior art liquid-liquid centrifuges is the manufacturing cost is significantly less for comparable sized units. The manufacturing cost for the centrifuge of the present invention is one-fourth to one-third compared to similar units existing in the market today. Operating costs also are significantly lower. This unique advantage greatly expands the potential uses of centrifuge in liquid-liquid separation across many industries.

Also, the apparatus of the present invention operates essentially without air being introduced into the separator, which would otherwise form a third phase changing fluid dynamics of the system and separation rates. Thus, the apparatus operates producing minimal grunge reducing chemistry and waste treatment costs. Based on the design, conventional centrifugal separators operate with air entrained in the liquid solution. This entrained air reduces separation efficiency and also accelerates organic solvent degradation, which increases operating cost. The air entrained in conventional centrifugal separators results in a third phase formation in the rotating cylinder, 1) air, 2) light liquid phase, and 3) heavy liquid phase. The cylinder volume occupied by the air phase reduces the available working separation volume for the two liquids. This reduced volume occupied by the two liquids lowers residence time that, in turn, decreases separation efficiency for a given cylinder size operating at the same conditions.

Moreover, since the apparatus of the present invention operates with minimal or essentially no third phase, fire hazards are reduced as well as potential environmental impact, which may have a direct effect on insurance and safety costs.

Still other advantages of the apparatus of the present invention is that the apparatus may be independently controlled, regardless of input flows to facilitate maximum separation efficiencies. Conventional mixture settlers operate at 1 “g” and mixture settlers presently available in the marketplace can only operate within a narrow “g” range. To accommodate different “g” ranges requires fabricating a new machine. The separator of the present invention can be adjusted for different “g” ranges in matter of minutes by adding or subtracting plugs in top plate 40.

Additionally, because of the versatility of the apparatus of the present invention, the apparatus may be computer controlled, reducing the number of operating personnel and costs associated therewith, may be monitored and controlled remotely, and may have a smaller footprint, which in turn may result in reduced; installation and operating costs. Indeed, the cost to manufacture the apparatus of the present invention may be as little as one quarter to one third that of conventional centrifuges of similar through-put capacities.

Another significant and unique aspect of the apparatus of the present invention is the reduction in air or vapor entrainment within the liquid phases. The inlet and outlet piping as well as the chambers within this centrifuge device are designed to reduce and essentially eliminate air/vapor entrainment. Existing liquid-liquid centrifuges are designed and operated with air/vapor entrainment within the liquid phases. The apparatus of the present invention is designed to prevent air/vapor entrainment within the liquid phases. This results in three important process advantages:
1. Elimination of air/vapor results in better separation, which reduces entrainment of one liquid phase in the other liquid phase after separation occurs.
2. Elimination of air/vapor results in more volume occupied by the liquid phases within the separation chamber. More volume occupied by the liquids results in more residence time and greater separation efficiency for a given centrifuge volume.
3. Elimination of air/vapor results in less degradation of the organic solvent that lowers operating cost.

Because of its versatility, the apparatus of the present invention may be used wide industrial applications, including also for economically separating oil from water such as encountered in oil spills. Still other features and advantages of the invention will be apparent to one skilled in the art.

1: An apparatus for separating a mixture of liquids of different densities or specific gravities, which liquids are substantially insoluble in each other, the apparatus comprising:
a stationary housing having a vertical side wall, a bottom wall and a top wall;
a separator tank having an outer wall within the housing, rotatably mounted about an axis of a center rotating shaft extending vertically through the tank;
the tank having an inlet adjacent the lower end of the tank for introduction of the mixture of liquids;
the separator tank having an unimpeded internal volume other than a horizontal diverter plate carried on the shaft, spaced adjacent and above the lower end of the tank, for deflecting the mixture of liquids introduced adjacent the lower end of the tank towards an interior of the outer wall of the separator tank, the shaft having a plurality of radially short vertical plates mounted on a periphery of the shaft above the horizontal diverter plate;
a riser tube and outlet adjacent the upper end of the tank substantially on the axis of rotation;
an outlet port plate forming an upper end of the tank;
a plurality of outlet ports located in the center rotating shaft in the upper part of the tank for collection and discharge of the light phase liquid;
a plurality of outlets for heavier density liquids formed through the outlet port plate, the plurality of outlets for the heavier density liquids being spaced at different distances from the axis;
a plurality of removable plugs in selected of the outlets in the outlet port plate;
one or more removable access plates in the top wall of the stationary housing for providing direct access to said plurality of removable plugs; and
an upper interface plate between a lower end of the riser tube and the outlet port plate, the upper interface plate substantially lying in a plane transverse to the separator tank axis of rotation, and spaced from the stationary housing,
wherein said separator tank during operation, and as a result of said unimpeded internal volume and short vertical plates creates reduced air entrainment and improved separator efficiency as compared to a conventional rotatably mounted separator tank of similar size operating at the same conditions, and having vertical baffles that extend to adjacent an interior surface wall of the separator tank.

2. (canceled)

3: The apparatus of claim 1, wherein at least some of the plurality of outlets in the outlet port plate lie on substantially concentric circles.

4: The apparatus of claim 3, wherein the plurality of outlets in the outlet port plate are threaded to accommodate threaded removable plugs.

5. (canceled)

6. (canceled)

7: A method for separating a mixture of liquids of different densities with specific gravities which are substantially insoluble in each other, a method comprising:
providing an apparatus as claimed in claim 1;
introducing the mixture of liquids into the lower end of the tank;
rotatably driving the separator tank whereby to separate the fluids into a heavy phase fluid and a lighter phase fluid; and
separately withdrawing the heavy phase fluid and lighter phase fluid from the tank.

8: The method of claim 7, wherein the mixture of liquids are introduced to the tank in the inlet adjacent the lower end of the tank, and the heavier phase fluid and the lighter phase fluid are separately withdrawn from the top of the apparatus.

9: The method according to claim 8, wherein the lighter phase fluid is withdrawn from the outlet ports located in the center rotating shaft.

10: The method according to claim 7, wherein the mixture of liquids comprise a mixture of a water-immiscible organic liquid and water.
